(19) United States
(12) Patent Application Publication
(10) Pub. No.: US 2016/0167509 A1
(43) Pub. Date: Jun. 16, 2016

(54) GAS CAP REPLACEMENT DEVICE

(71) Applicant: Tony Bost, Sumner, TX (US)

(72) Inventor: Tony Bost, Sumner, TX (US)

(21) Appl. No.: 14/571,484

(22) Filed: Dec. 16, 2014

(51) Int. Cl. B60K 15/04

(52) U.S. Cl. CPC B60K 15/0406; B60K 2015/0432

(57) ABSTRACT

A gas cap replacement device comprising: a tube, where the tube includes a downward cone shape; sponge material surrounding an outside surface of the tube; a lid covering the top of the tube; a flat facing surrounding the lid; a sponge ring surrounding the flat facing; and a means to attach and secure the gas cap replacement device into a fuel port of a vehicle. In one particular embodiment, the sponge material may include silicone and the diameter of the tube and sponge material is preferably 2½ inches. Further stoppers may extend from each side of the tube below the sponge material. In one particular embodiment, the means to attach and secure includes elastics bands used with an elastic string and tensioner.

### BACKGROUND OF THE INVENTION

1. Field of Invention

The present invention relates to a gas cap replacement device that replaces the traditional gas cap used on many automobiles and other vehicles in order to reduce the emission of vapors and fumes from the gas tank.

2. Description of Related Art

Most motor vehicles are powered through petroleum products in particular gas and diesel fuels. The user of a vehicle typically fuels the gas tank through the removal of a twist-on gas cap and then inserts a dispensing nozzle into the opening provided under the gas cap. Once the fuel cap is removed the possibility of escaping vapors and fumes arises while fueling the vehicle. By exposing the user to these flammable vapors the fueling process may easily become very hazardous. It is noted that it is absolutely imperative not to smoke while fueling a vehicle and it is advisable not to use any electronic devices such as a cellular phone while fueling a vehicle. However the risk of escaping vapors remains regardless of the practices of the user. It would therefore be advantageous to have a device that could replace the traditional fuel port and the twist-on lid that is used in most vehicles. It further would be advantageous to have a device that substantially reduces the escaping vapors and fumes from the gas tank during the fueling process.

### SUMMARY OF THE INVENTION

The present invention relates to a gas cap replacement device comprising: a tube, where the tube includes a downward cone shape; sponge material surrounding an outside surface of the tube; a lid covering the top of the tube; a flat facing surrounding the lid; a sponge ring surrounding the flat facing; and a means to attach and secure the gas cap replacement device into a fuel port of a vehicle. In one particular embodiment, the sponge material may include silicone and the diameter of the tube and sponge material is preferably 2½ inches. Further stoppers may extend from each side of the tube below the sponge material. In one particular embodiment, the means to attach and secure includes elastics bands used with an elastic string and tensioner.

### BRIEF DESCRIPTION OF DRAWINGS

FIG. 1 depicts a gas cap replacement device in accordance with the present invention.

### DETAILED DESCRIPTION

The present invention relates to a gas cap replacement device that is non-flammable, and has zero static properties that may be mounted into the fuel port of a motor vehicle. Once mounted into the fuel port the user may discard the traditional twist-on cap that is typically used to close the fuel port of a motor vehicle. The present invention fits inside the fuel port insert area and once inserted a closing lid may be used to close over the fuel port and the gas cap replacement device. As a consequence, the gas cap replacement device once properly installed may be mounted within the fuel port. The gas cap replacement device includes a circular lid and a tube that fits into the fuel port area. This tube is in sync with the typical sizing of a fuel port, which is usually between 2 and 2½ inches in diameter. Along an outside surface of the tube is a non-flammable sponge that fills the opening of the fuel port to prevent the escaping of fumes and vapors.

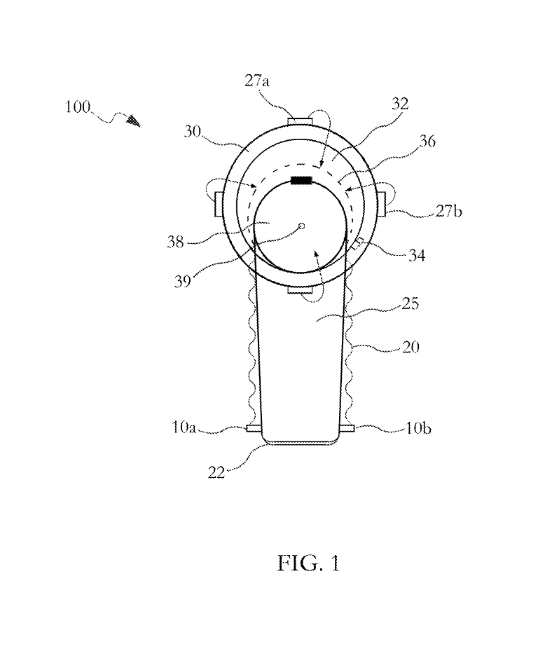

In reference to FIG. 1, a prospective view of the gas cap replacement device in accordance with the present invention is depicted. As shown in FIG. 1, a gas cap replacement device 100 includes a tube 25 that extends downwardly from a lid 38. The tube 25 includes a non-flammable sponge material 20 on an outer surface of the tube 25. This sponge material 20 in one particular embodiment may be silicone and is preferably sized at 2½ inches in diameter measuring from the outside of the circular ring. At the top of the tube 25 is a clear silicone flat flexible facing 32, which is the same silicone flat facing that creates the material for the lid 38. The lid 38 allows access to the fuel port and enables for the insertion of a dispensing nozzle into the gas cap replacement device 100.

Other features of the gas cap replacement device 100 includes the tubing 25 which has a downward cone shape, which includes a flexible clear non-flammable silicone portion that includes a expandable diameter of 11/16 of an inch. This 11/16 inch diameter dimension, shown at 22, is at the bottom of the downward cone design of the tube 25. This shape and design provides a snug fitting within the fuel port and ensures that little or no vapors escape while the user is pumping the fuel. Stoppers 10a, 10b extend from each side of the tube 25. Just above the stoppers 10a, 10b is the sponge material 20 that provides the sealing of the tube into the existing fuel port of a vehicle. The lid 38 includes a hole 39 at the center that acts as a fume pressure release hole for the safety of the user. This pressure release hole 39 does not interfere with the function of the lid 30 but is effective once the lid 38 is closed allowing a small amount of pressure to be released from the fuel tank. Another feature of the present invention are the elastic bands 27a, 27b that connect to the top side of the silicone flat facing and at the ends of each elastic band is an elastic string. These bands 27a, 27b stretch downwards over the fuel port tube 25. Surrounding the facing area 32 is a sponge ring 30 that provides a further seal sealing the fuel port and therefore preventing the escape of fumes and vapors from the fuel tank. An elastic string 36 used in conjunction with a tensioner 34 helps to secure the gas cap replacement device into the fuel port.

During use, the user removes the traditional twist-on fuel cap and then inserts the gas cap replacement device in accordance with the present invention. The downward cone non-flammable silicone design fits into the fuel port area where the cap has been removed. Once into place the device is pressed downward so that the silicone sponge ring will slightly compress creating a initial seal and then the attachment is completed by using the four elastic bands where the bands are made of zero static materials. The elastic bands are spaced evenly around the perimeter of the gas cap replacement device and helps to secure the replacement device into place within the fuel port. The tensioner 34 and elastic string 36 helps to further seal the gas cap replacement device 100 into place within the fuel port. As a consequence the present invention provides both a device and a method to reduce the emission of fumes from a fuel port of a traditional gas tank.

What is claimed is:

1. A gas cap replacement device comprising:
a. a tube, where the tube includes a downward cone shape;
b. sponge material surrounding an outside surface of the tube;
c. a lid covering the top of the tube;
d. a flat facing surrounding the lid;
e. a sponge ring surrounding the flat facing; and
f. a means to attach and secure the gas cap replacement device into a fuel port of a vehicle.

2. The gas cap replacement device according to claim 1, where the sponge material includes silicone.

3. The gas cap replacement device according to claim 1, further including stoppers extending from each side of the tube below the sponge material.

4. The gas cap replacement device according to claim 1, further including a hole at the center of the lid, where the hole provides pressure release.

5. The gas cap replacement device according to claim 1, where the means to attach and secure includes elastics bands used with an elastic string and tensioner.

6. A method of gas cap replacement comprising the steps of:
a. removing a twist type gas cap from a vehicle's fuel port;
b. inserting a gas cap replacement device where the replacement device includes a downward cone shaped tube with a sponge material outer surface;
c. securing the gas cap replacement device by using a system of elastic bands, elastic string and a tensioner.
